(19) United States
(12) Patent Application Publication
(10) Pub. No.: US 2012/0102353 A1
(43) Pub. Date: Apr. 26, 2012

(54) DATA PROCESSING APPARATUS, DATA PROCESSING SYSTEM, MEASUREMENT SYSTEM, DATA PROCESSING METHOD, MEASUREMENT METHOD, ELECTRONIC DEVICE AND RECORDING MEDIUM

(75) Inventors: Takahiro YAMAGUCHI, Saitama (JP); Mani SOMA, Seattle, WA (US); Takafumi AOKI, Miyagi (JP); Yasuo FURUKAWA, Saitama (JP); Katsuhiko DEGAWA, Saitama (JP)

(73) Assignees: NATIONAL UNIVERSITY CORPORATION TOHOKU UNIVERSITY, Miyagi (JP); ADVANTEST CORPORATION, Tokyo (JP)

(21) Appl. No.: 13/022,502

(22) Filed: Feb. 7, 2011

Related U.S. Application Data
(60) Provisional application No. 61/405,606, filed on Oct. 21, 2010.

(51) Int. Cl. G06F 1/04

(52) U.S. Cl. 713/500

(57) ABSTRACT

Provided is a data processing system that processes input data, comprising a data generating apparatus that generates the input data and a data processing apparatus that processes the input data generated by the data generating apparatus. The data processing apparatus includes a time interpolation section that generates time interpolated data, in which level differences between pieces of data adjacent in time are a constant value, based on the input data.

### BACKGROUND

1. Technical Field

The present invention relates to data processing apparatus, a data processing system, a measurement system, a data processing method, a measurement method, an electronic device, and a recording medium.

2. Related Art

A known measurement method for measuring a signal under measurement involves sampling the signal under measurement at uniform time intervals using a multi-bit AD converter or the like. The multi-bit AD converter can be formed by a plurality of comparators provided with different reference voltages.

However, the measurement data acquired using a multi-bit AD converter includes a quantization error of the AD converters in amplitude. Therefore, it is difficult to accurately measure the waveform of the signal under measurement.

Furthermore, aliasing occurs when a Fourier transform is performed on the waveform sampled at uniform intervals. Therefore, in order to measure an accurate spectrum from the data sampled at uniform intervals, it is necessary to remove the aliasing components using an analog filter or the like.

After the signal under measurement is measured, the data interval of the sampling data may be interpolated. A known method for interpolating the sampling data involves calculating the amplitude value of interpolated data at an intermediate timing between two sampling timings, based on two sampling values. However, if the signal under measurement has a large slope, the error in amplitude increases when calculating the amplitude value of interpolated data at a prescribed timing. The following document is provided as Prior Art.

Document 1: E. Allier, G. Sicard, L. Fesquet, M. Renaudin, “A new class of asynchronous A/D converters based on time quantization,” in Proc. IEEE Int. Sym. Asynchronous Circuits Syst., pp.196-205, Vancouver, BC. Canada, May 2003.

### SUMMARY

Therefore, it is an object of an aspect of the innovations herein to provide a data processing apparatus, a data processing system, a measurement system, a data processing method, a measurement method, an electronic device, and a recording medium, which are capable of overcoming the above drawbacks accompanying the related art. The above and other objects can be achieved by combinations described in the independent claims. According to a first aspect related to the innovations herein, provided is a data processing apparatus that processes input data input thereto, comprising a time interpolation section that generates time interpolation data, in which level differences between pieces of data adjacent in time are a constant value, based on the input data. Also provided is a data processing method utilizing the data processing apparatus.

According to a second aspect related to the innovations herein, provided is a data processing system that processes input data, comprising a data generating apparatus that generates the input data; and the data processing apparatus according to the first aspect that processes the input data generated by the data generating apparatus.

According to a third aspect related to the innovations herein, provided is a measurement system that measures a signal under measurement, comprising a data measurement apparatus that generates measurement data obtained by measuring the signal under measurement; and the data processing apparatus according to the first aspect that processes the measurement data generated by data measurement apparatus. Also provided is a measurement method utilizing the measurement system and an electronic device provided with the measurement system.

According to a fourth aspect related to the innovations herein, provided is a recording medium storing thereon a program that causes a computer to function as the data processing apparatus according to the first aspect.

The summary clause does not necessarily describe all necessary features of the embodiments of the present invention. The present invention may also be a sub-combination of the features described above.

### BRIEF DESCRIPTION OF THE DRAWINGS

FIG. 1 shows an exemplary configuration of a measurement system 300 that measures a signal under measurement.

FIG. 2 shows an exemplary operation of the level-crossing measuring section 210.

FIG. 3 shows waveform data generated by the level-crossing measuring section 210.

FIG. 4 shows a waveform obtained by plotting the quantized times Q[tk] detected for the threshold levels.

FIG. 5 shows an exemplary function block configuration of the data processing apparatus 100.

FIG. 6 shows exemplary measurement data input to the data processing apparatus 100.

FIG. 7 shows exemplary time-interpolated data.

FIG. 8 shows examples of a rising edge portion 14, a falling edge portion 15, and boundary data 19.

FIG. 9 shows another exemplary configuration of the measurement apparatus 200.

FIG. 10 shows an exemplary configuration of the time-to-digital converting section 240.

FIG. 11 shows another exemplary configuration of the time-to-digital converting section 240.

FIG. 12 shows another exemplary configuration of the time-to-digital converting section 240.

FIG. 13 shows another exemplary configuration of the measurement apparatus 200.

FIG. 14 shows a spectrum measured by the measurement system 300 and a spectrum measured by a spectrum analyzer.

FIG. 15 shows measurement results of the SINAD and the SNR values of the measurement system 300.

FIG. 16 shows an exemplary hardware configuration of a computer 1600 functioning as the data processing apparatus 100.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

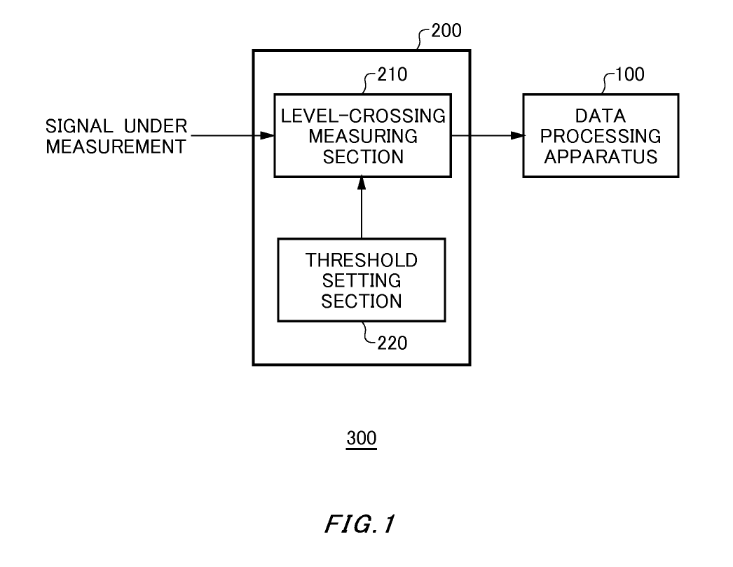

FIG. 1 shows an exemplary configuration of a measurement system 300 that measures a signal under measurement. The measurement system 300 includes a measurement apparatus 200 and a data processing apparatus 100.

The measurement apparatus 200 measures a level-crossing time of the signal under measurement for each of a plurality of threshold levels. The data processing apparatus 100 processes measurement data generated by the measurement apparatus 200. The measurement apparatus 200 includes a level-crossing measuring section 210 and a threshold setting section 220.

The level-crossing measuring section 210 measures the time at which the signal under measurement crosses each of the set threshold levels. The threshold setting section 220 sets the threshold levels in the level-crossing measuring section 210.

The measurement apparatus 200 may sequentially perform the measurement for each threshold level. In this case, the measurement apparatus 200 includes one level-crossing measuring section 210. The threshold setting section 220 sets a subsequent value for the threshold level each time the level-crossing measuring section 210 samples the signal under measurement in a prescribed period.

The measurement apparatus 200 may perform measurements for the plurality of threshold levels in parallel. In this case, the measurement apparatus 200 includes a plurality of level-crossing measuring sections 210. The threshold setting section 220 sets a different threshold level for each level-crossing measuring section 210.

The data processing apparatus 100 can also be used to process input data other than the measurement data from the measurement apparatus 200. For example, the data processing apparatus 100 may process input data generated by a data generating apparatus that generates input data using predetermined hardware or software, such as EDA (Electronic Design Automation).

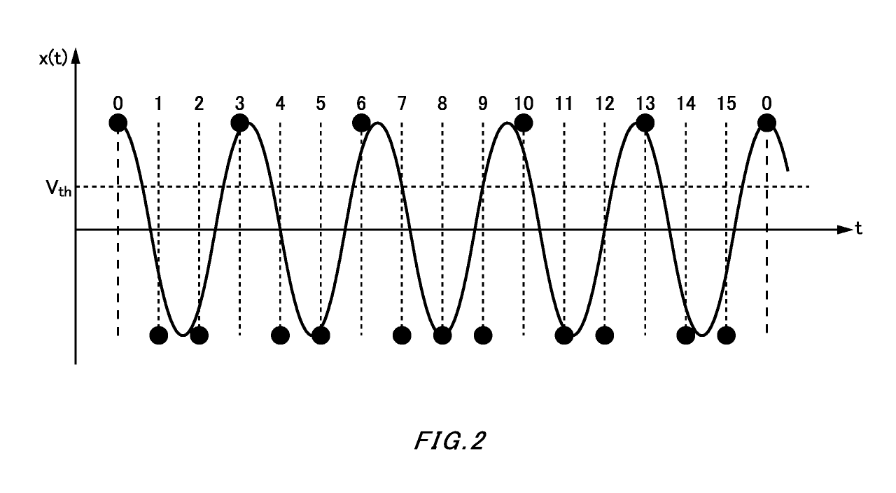

FIG. 2 shows an exemplary operation of the level-crossing measuring section 210. In FIG. 2, the horizontal axis represents time and the vertical axis represents the signal level of the signal under measurement. The signal under measurement in this example is a sinusoidal signal.

The level-crossing measuring section 210 of the present embodiment outputs a comparison result between the signal level of the signal under measurement and the threshold level Vth, for each threshold level Vth that is set. These comparison results correspond to the measurement data described above. The level-crossing measuring section 210 may output the comparison results in a prescribed sampling period.

In FIG. 2, the black circles (0, 3, 6, 10, 13) in the upper region indicate comparison results for which the signal level of the signal under measurement is greater than or equal to the threshold level Vth. The black circles (1, 2, 4, 5, 7, 8, 9, 11, 12, 14, 15) in the lower region indicate comparison results for which the signal level of the signal under measurement is less than the threshold level Vth. The comparison result at the k-th sampling time is expressed as x[k]. In the present example, k=0, 1, 2, . . . , 15.

The level-crossing measuring section 210 of the present embodiment performs oversampling or coherent sampling of the signal under measurement. Coherent sampling is sampling in which MT=NTs, where M and N are coprime integers, T is the period of the signal under measurement, and Ts is the sampling period. In the example of FIG. 2, M=5 and N=16.

The level-crossing measuring section 210 reconfigures one cycle of the waveform data of the signal under measurement from N pieces of sampling data, i.e. N comparison results, by rearranging the sampling data according to the period T of the signal under measurement and the sampling period Ts, or according to the integers M and N. The level-crossing measuring section 210 detects a time at which the comparison result transitions, based on the reconfigured waveform data.

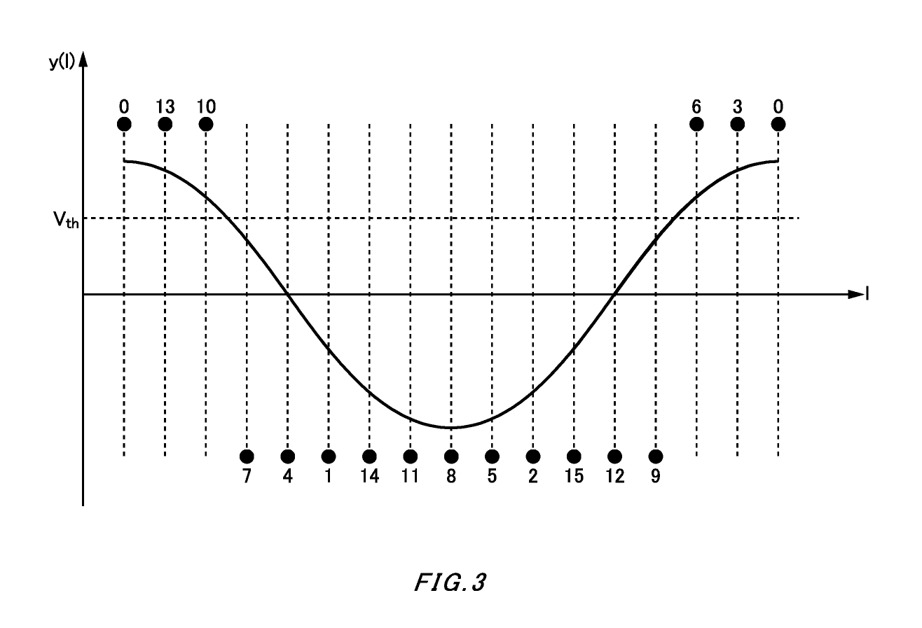

FIG. 3 shows waveform data generated by the level-crossing measuring section 210. The level-crossing measuring section 210 may reconstruct the waveform data by reordering the measurement data based on the expression below.

y[l]=x[lM MOD N] Expression 1

Here, l=0, 2, . . . , 14, 15. Furthermore, the level-crossing measuring section 210 may generate the waveform data shown in FIG. 3 by oversampling the signal under measurement.

As shown in FIG. 3, the time at which the signal under measurement crosses the threshold level Vth, referred to as the quantized time Q[tk], can be detected from the time sequence over which the logic values of the reordered waveform data change. This time is quantized with a temporal resolution of the equivalent sampling time T/N of the coherent sampling.

In this example, at the time between l=2 and l=3 (k=10 and k=7) and the time between l=13 and l=14 (k=9 and k=6), the signal under measurement crosses the threshold level. The quantized times Q[tk] detected in this example are 3 and 14. The level-crossing measuring section 210 detects a quantized time Q[tk] for each threshold level.

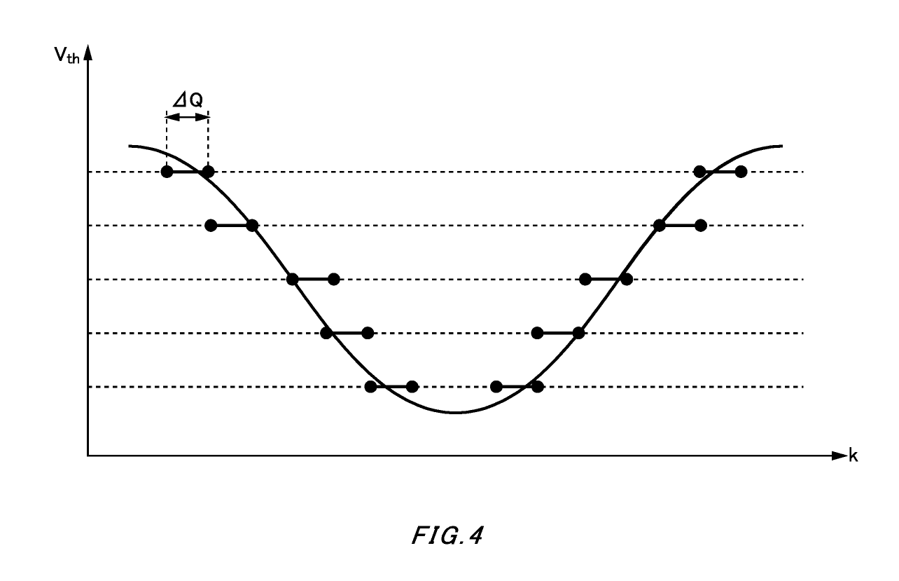

FIG. 4 shows a waveform obtained by plotting the quantized times Q[tk] detected for the threshold levels. In FIG. 4, the vertical axis represents the threshold level and the horizontal axis represents time. Each quantized time Q[tk] has a quantization error ΔQ=T/N in time, as shown in FIG. 4.

As shown in FIGS. 2 to 4, the waveform data of the signal under measurement can be reordered using level-crossing detection comparators, by detecting the quantized times Q[tk] for the plurality of threshold levels. The time intervals of the reconstructed pieces of waveform data are non-uniform.

The threshold levels sequentially set by the threshold setting section 220 may be at uniform intervals, or may be at non-uniform intervals. The threshold setting section 220 may set large intervals between threshold levels in a region where the slope of the signal under measurement is large, and set small intervals between threshold levels in a region where the slope of the signal under measurement is small.

The level-crossing measuring section 210 outputs comparison results between the threshold levels and the signal level of the signal under measurement. Therefore, the measurement data measured by the measurement apparatus 200 does not include an amplitude quantization error of the signal under measurement. As a result, the noise component associated with the amplitude quantization in the measured data is smaller than if the signal under measurement is measured using a multi-bit AD converter.

As shown in FIG. 4, the measurement data measured by the measurement apparatus 200 includes a quantization error in time. However, this quantization error is diminished by increasing the sampling frequency, or the equivalent sampling frequency in the case of coherent sampling. Therefore, accurate measurement data can be easily acquired. It is particularly easy to acquire accurate measurement data when using coherent sampling, because a high equivalent sampling frequency can be achieved using a clock source with a relatively low frequency.

On the other hand, a quantization error is present in the quantized amplitude when the signal under measurement is measured using a multi-bit ADC converter, and therefore, in the best case, the quantization error is decreased by −3 dB/oct by increasing the sampling frequency. Therefore, it is difficult to accurately measure the signal under measurement with uniform interval sampling using a multi-bit AD converter.

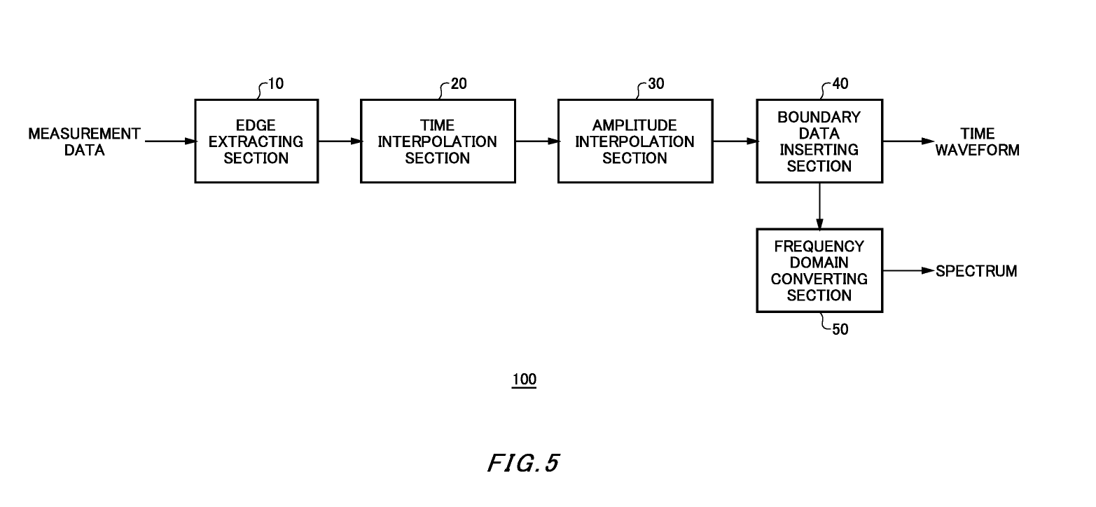

FIG. 5 shows an exemplary function block configuration of the data processing apparatus 100. The data processing apparatus 100 includes an edge extracting section 10, a time interpolation section 20, an amplitude interpolation section 30, a boundary data inserting section 40, and a frequency domain converting section 50.

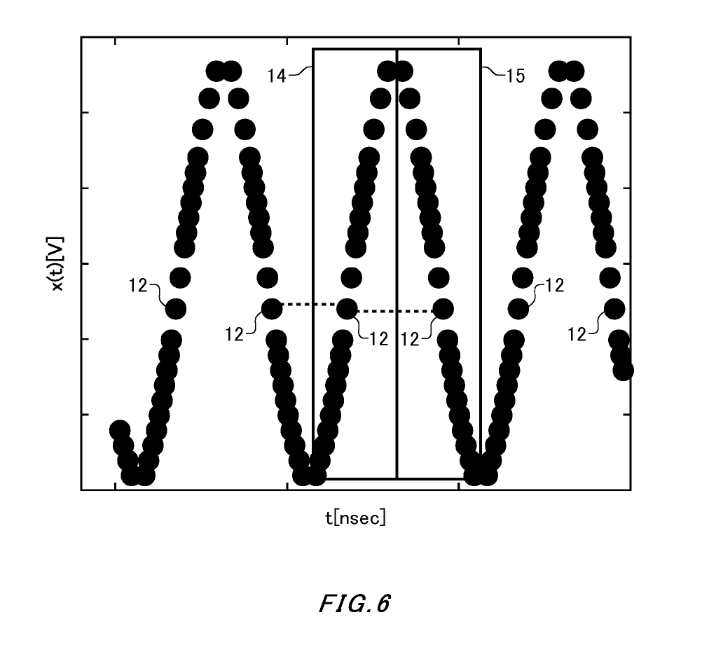

FIG. 6 shows exemplary measurement data input to the data processing apparatus 100. The measurement data in this example is obtained by detecting times at which a sinusoidal signal crosses each of a plurality of threshold levels.

The edge extracting section 10 divides the measurement data into rising edge portions 14 and falling edge portions 15, and extracts these portions. The edge extracting section 10 may extract the rising edge portions 14 and the falling edge portions 15 based on the pieces of data 12 corresponding to a prescribed threshold level. This prescribed threshold level may be a level that is 50% of the amplitude of the signal under measurement.

The edge extracting section 10 may calculate the average width of the intervals between pieces of data 12 that are adjacent in time. The edge extracting section 10 may set, as a rising edge portion 14 or a falling edge portion 15, the pieces of data within a range that is centered on a piece of data 12 and equal to the calculated average width. As a result, the rising edge portions 14 and the falling edge portions 15 can be separated and extracted from the measurement data.

The time interpolation section 20 generates time interpolation data, in which level differences between temporally adjacent pieces of data are constant, based on the measurement data. The time interpolation section 20 of the present embodiment generates the time interpolation data for each rising edge portion 14 and falling edge portion 15 extracted by the edge extracting section 10.

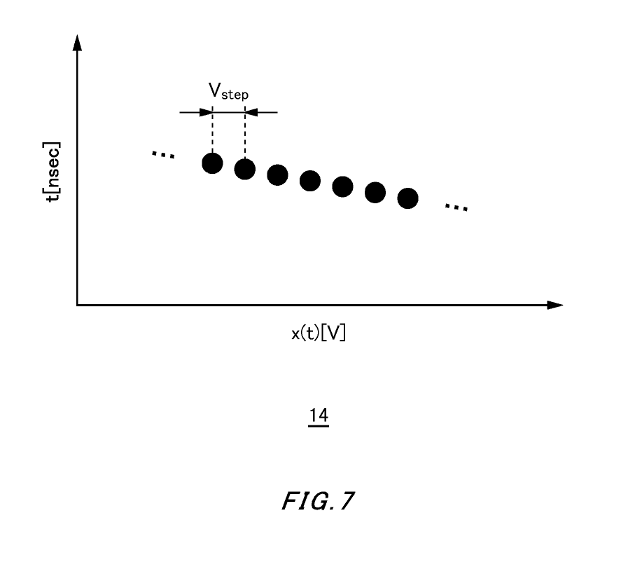

FIG. 7 shows exemplary time interpolated data. FIG. 7 shows a portion of time interpolated data of a rising edge portion 14 or a falling edge portion 15. The time interpolation section 20 performs time interpolation for the measurement data (Vk, Q[tk]) of each edge portion, and calculates tj for uniform intervals of jVstep, where j is a natural number. In this case, the following expressions can be used.

Vₖ=x(tₖ)

Q[tₖ]=Q[sin⁻¹(Vₖ/2πƒᵢₙ)

Here, fᵢₙ is the frequency of the signal under measurement.

The time interpolation section 20 may generate the time interpolation data by performing spline interpolation on the measurement data. For example, the time interpolation section 20 may calculate the time tm of the interpolated data at an amplitude mVstep by performing spline interpolation between two pieces of data having amplitudes that sandwich the amplitude mVstep in the measurement data. The amplitude interval Vstep between pieces of time interpolation data may be less than the amplitude interval between pieces of measurement data.

The time interpolation section 20 may generate time interpolated data by inserting interpolated data between each adjacent pair of data pieces in the measurement data. If the amplitude intervals in the measurement data are uniform, i.e. if the intervals between the threshold levels Vth are uniform, the time interpolation section 20 may insert the same number of pieces of interpolated data between each pair of measurement data pieces. By performing this type of interpolation, accurate interpolated data can be generated for edge portions of the signal under measurement having large slopes.

The amplitude interpolation section 30 generates amplitude interpolated data, which causes the time error between pieces of data adjacent in time to be constant, based on the time interpolated data generated by the time interpolated section 20. The amplitude interpolation section 30 may generate the amplitude interpolated data for each rising edge portion 14 and falling edge portion 15 of the time interpolated data.

The amplitude interpolation section 30 performs amplitude interpolation on each piece of data (tj, Vj) of the time interpolated data to calculate Vn for the uniform interval time n. The amplitude interpolation section 30 may calculate Vn for the uniform interval time n using interpolation processing in which the times (timings) and amplitudes are switched in the process performed by the time interpolation section 20.

The boundary data inserting section 40 inserts boundary data at the boundaries between the rising edge portions 14 and the falling edge portions 15 in the amplitude interpolated data generated by the amplitude interpolation section 30. The boundary data can be calculated from the data values of the rising edge portions 14 and the falling edge portions 15.

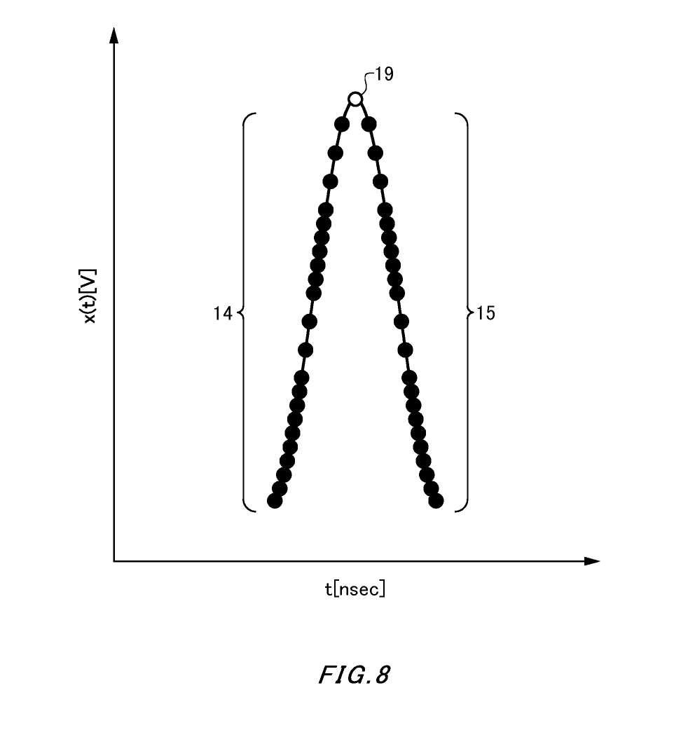

FIG. 8 shows examples of a rising edge portion 14, a falling edge portion 15, and boundary data 19. The boundary data inserting section 40 calculates the boundary data 19 by approximating the rising edge portion 14 and the falling edge portion 15 to a known waveform of the signal under measurement.

Since the signal under measurement in this example is a sinusoidal signal, the boundary data inserting section 40 calculates the boundary data 19 by calculating the amplitude value at the time of the boundary between the rising edge portion 14 and the falling edge portion 15 in the approximated sine wave.

The boundary data inserting section 40 may calculate the approximated sine wave such that the signal-to-noise ration (SNR) of the spectrum of the time interpolated data having the boundary data 19 inserted therein is maximized. For example, the boundary data inserting section 40 may calculate the amplitude and offset of a sine wave that maximizes the SNR.

The boundary data inserting section 40 may insert the boundary data 19 into the measurement data input to the time interpolation section 20, or may insert the boundary data 19 to the measurement data input to the amplitude interpolation section 30.

The boundary data inserting section 40 may insert one or more pieces of boundary data 19 between the rising edge portion 14 and the falling edge portion 15, such that a time interval is obtained that is equal to the time interval of the amplitude interpolated data. With the above processing, the waveform of the signal under measurement in time is reconstructed.

The frequency domain converting section 50 converts the amplitude interpolated data having the boundary data 19 inserted therein into a signal in the frequency domain. The frequency domain converting section 50 may perform a Fourier transform on the amplitude interpolation data.

The SNR of the level-crossing AD converter with respect to a sinusoidal signal with a frequency fᵢₙ can be expressed as shown below, as described by Document 1.

SNR=−11.19+20 log₁₀R [dB] Expression 2

As described in relation to FIG. 4, the noise in the measurement data is time quantization noise caused by the time resolution Tc of a time-to-digital converter, and therefore the SNR is a function of the resolution ratio R=1/(fᵢₙTc).

If the resolution ratio R is not sufficiently large, the time quantization noise causes not only a noise floor but also in-band harmonics. At this time, the signal-to-noise and distortion (SINAD) is expressed as shown below.

SINAD=−10 log₁₀[10^{-SNR/10}+10^{THD/10}] [dB] Expression 3

Therefore, SINAD is a suitable criterion for evaluating the in-band time quantization noise.

Next, when the uniform time interval x_{unif}[k] is acquired from x(ti), whose time intervals are non-uniform, using an ideal interpolator, the resolution ratio R increases and causes a decrease in the interpolation error ΔV, as shown by the expression below.

ΔV≈(dV/dt)Δt+(d²V/dt²)(Δt)²

As a result, the interpolation error power can be shown by Expression 4 below.

|ΔV|²≈{(2π/R)[1+(2π/R)]}² Expression 4

Based on Expression 4, the noise-to-signal ratio (NSR) of the interpolated signal can be expressed by Expression 5 shown below.

NSR=−20 log₁₀(R/2π)−20 log₁₀(1+R/2π) [dB] Expresssion 5

Based on Expressions 2 and 5, the SNR of the uniform interval x_{unif}[k] can be expressed by Expression 6 shown below.

SNR_{unif}=SNR−NSR>40 log₁₀(R/2π) [dB] Expression 6

Expression 6 shows that a combination of a sufficiently large R and an ideal interpolator can acquire the uniform interval x_{unif}[k] with a large SNR from the non-uniform interval x(ti). Here, SNR_{unif} can be measured by performing a fast Fourier transform on x_{unif}[k] and observing the time quantization noise that is out-of-band, i.e. the frequency that does not contain harmonics.

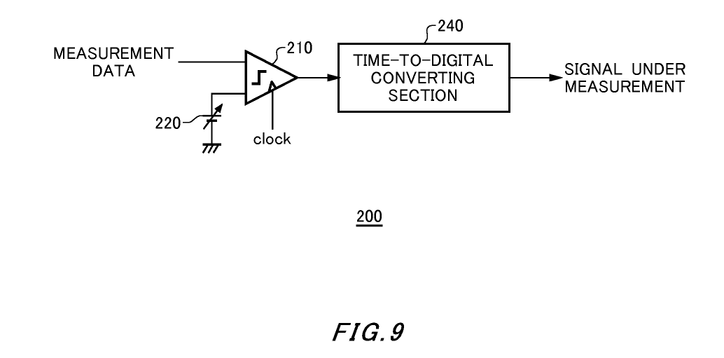

FIG. 9 shows another exemplary configuration of the measurement apparatus 200. The measurement apparatus 200 of the present embodiment includes a level-crossing measuring section 210, a threshold setting section 220, and a time-to-digital converting section 240.

The level-crossing measuring section 210 includes a clocked comparator that outputs comparison results between the signal level of the signal under measurement and threshold levels. The clocked comparator outputs comparison results between the signal level of the signal under measurement and the threshold levels in a predetermined sampling period, i.e. clock. For example, the clocked comparator may output comparison results obtained by sampling the signal level of the signal under measurement according to the sampling period and comparing the sampling results to the threshold levels. This sampling clock may have the sampling frequency fs described in relation to FIG. 2.

The threshold setting section 220 of the present embodiment is a variable voltage source that supplies a voltage corresponding to a set value to the level-crossing measuring section 210 as a threshold level. The time-to-digital converting section 240 generates digital values indicating the quantized times Q[tk] corresponding to each threshold level Vth, based on the comparison results output by the level-crossing measuring section 210 according to the sampling clock.

The time-to-digital converting section 240 includes a storage section that stores the output of the level-crossing measuring section 210. The time-to-digital converting section 240 process the data stored in the storage section, using hardware or software, to generate the digital value indicating the quantized time Q[tk]. The time-to-digital converting section 240 generates the quantized times Q[tk] by comparing predetermined combinations of the outputs of the level comparator stored in the storage section.

The level-crossing measuring section 210 may include a threshold detection comparator that outputs the values of measurement data changing at level-crossing times at which the signal level of the signal under measurement crosses the threshold level. The values output by the threshold detection comparator may change by being delayed by a prescribed delay amount from the level-crossing time. The measurement apparatus 200 may output, as the measurement data, digital values indicating the times at which the values output by the threshold detection comparator transition. The measurement apparatus 200 may generate these digital values from the results obtained by sampling the output of the threshold detection comparator. When the level-crossing measuring section 210 includes the threshold detection comparator, the measurement apparatus 200 need not include the time-to-digital converting section 240.

As described above, a plurality of level-crossing measuring sections 210 may be provided. In this case, the threshold setting section 220 sets a different threshold level for each clocked comparator or each threshold detection comparator.

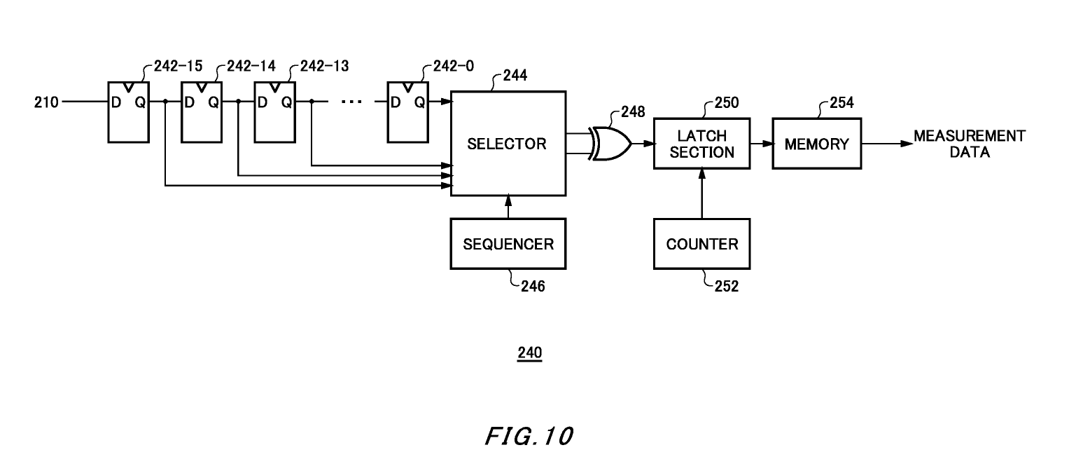

FIG. 10 shows an exemplary configuration of the time-to-digital converting section 240. The time-to-digital converting section 240 of the present embodiment uses hardware to generate a digital value indicating the quantized time Q[tk]. The time-to-digital converting section 240 includes a selector 244, a sequencer 246, an exclusive OR circuit 248, a latch section 250, a counter 252, a memory 254, and N flip-flops 242-0 to 242-15 connected in cascade (referred to simply as the flip-flops 242), with N being 16 in the present example.

Each flip-flop 242 sequentially receives data, i.e. comparison results, output by the level-crossing measuring section 210 according to the sampling clock, and sequentially passes the data in the order it was received to a flip-flop 242 at a later stage according to the sampling clock. In other words, the flip-flops 242 function as a storage section that stores the output of the level-crossing measuring section 210. When the flip-flops 242 have received N pieces of data from the level-crossing measuring section 210, the supply of the sampling clock to the flip-flops 242 may be stopped.

The selector 244 receives the data output by the flip-flops 242. The selector 244 sequentially selects two pieces of data output by two flip-flops 242 sequentially designated by the sequencer 246, and outputs the selected data.

The sequencer 246 sequentially designates combinations of two flip-flops 242 in a predetermined order. This predetermined order is determined according to the order of the pieces of data after reconfiguration, as shown in FIG. 3. In the example of FIG. 3, the sequencer 246 sequentially designates the two flip-flops 242-a and 240-b in an order of (a, b)=(0, 13), (13, 10), (10, 7), . . . , (9, 6), (6, 3).

The exclusive OR circuit 248 outputs the exclusive OR of each set of two pieces of data sequentially output by the selector 244. In other words, the exclusive OR circuit 248 outputs a logic value of 1 when the two pieces of data are different.

The counter 252 outputs a count value that is incremented at a prescribed period. This period is the same as the operation periods of the sequencer 246 and the selector 244. In other words, the counter 252 outputs a count value that is incremented every time the output of the selector 244 changes.

The latch section 250 latches the count value of the counter 252 when the exclusive OR circuit 248 outputs a logic value of 1. As a result, the latch section 250 latches the count value corresponding to the level-crossing time at which the signal under measurement crosses the threshold level.

In the example of FIG. 3, the counter 252 sequentially outputs a count value from 0 to 15. When the count value is 3, the output of the sequencer 246 is (10, 7) and the exclusive OR circuit 248 outputs a logic value of 1. Therefore, the latch section 250 latches the count value 3.

The memory 254 stores the count values latched by the counter 252. In the example of FIG. 3, the memory 254 stores the count values 3 and 14. These count values are the digital values indicating the quantization error Q[tk] for the corresponding threshold level.

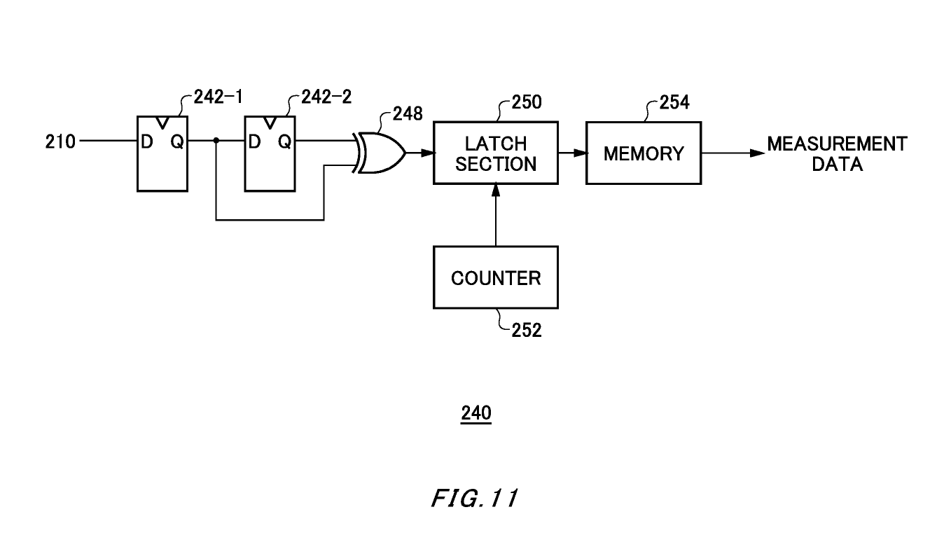

FIG. 11 shows another exemplary configuration of the time-to-digital converting section 240. The time-to-digital converting section 240 of the present embodiment includes two flip-flops 242-1 and 242-2, an exclusive OR circuit 248, a latch section 250, a counter 252, and a memory 254. Components in FIG. 11 that have the same reference numerals as components in FIG. 10 may have the same function and configuration as these components.

When using the time-to-digital converting section 240 of the present embodiment, the sampling clock of the level-crossing measuring section 210 has a period equal to the sum of the period of the signal under measurement and the time resolution Tc=T/N. In this case, rearranging the data sequentially output by the level-crossing measuring section 210 according to Expression 1 does not actually change the order of the data.

In this case, the level-crossing time at which the signal under measurement crosses the threshold level can be detected by comparing the data output by the level-crossing measuring section 210 to the data output immediately therebefore. In other words, the level-crossing time can be detected by comparing the outputs of the two flip-flops 242-1 and 242-2 connected in cascade, which operate according to the sampling clock.

The exclusive OR circuit 248 outputs the exclusive OR of the outputs from the two flip-flops 242-1 and 242-2. The counter 252 outputs a count value that is incremented according to the period of the sampling clock. The function of the latch section 250 and the memory 254 may be the same as the function of the latch section 250 and the memory 254 described in FIG. 10. With this configuration, the digital value indicating the quantized time Q[tk] can be detected.

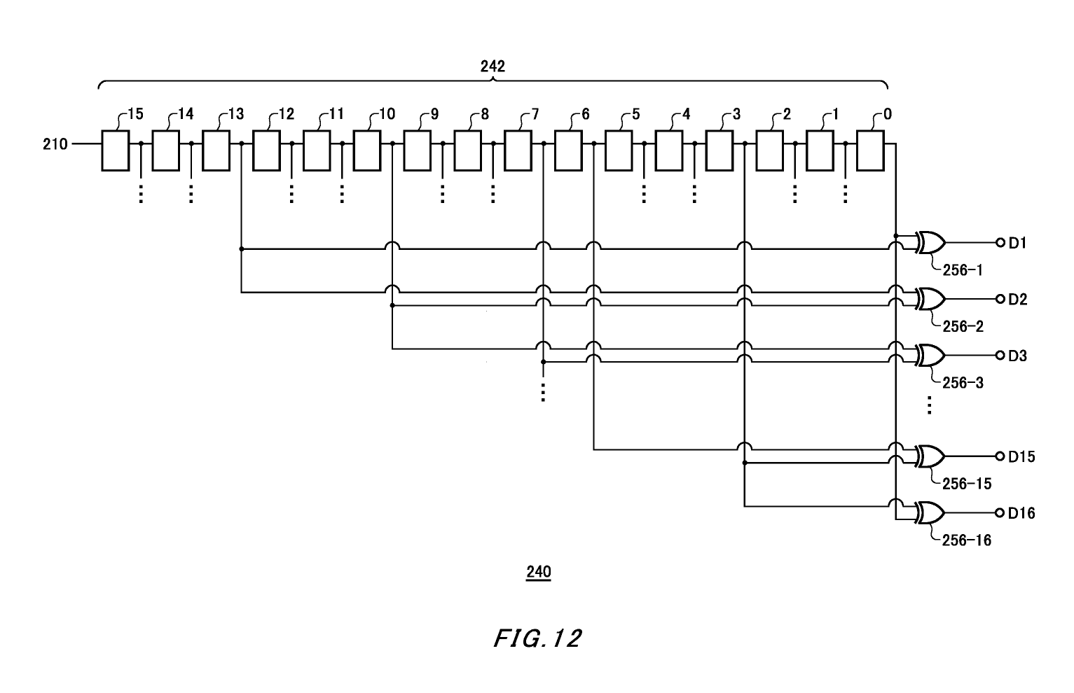

FIG. 12 shows another exemplary configuration of the time-to-digital converting section 240. The time-to-digital converting section 240 of the present embodiment includes N flip-flops 242 and N exclusive OR circuits 256-1 to 256-16 connected in cascade.

Each exclusive OR circuit 256 is connected to two flip-flops 242 predetermined for this exclusive OR circuit 256. Each exclusive OR circuit 256 is connected to two flip-flops 242 that are adjacent when the order of the N flip-flops 242 is rearranged according to Expression 1.

For example, when M=5 and N=16, the exclusive OR circuit 256-1 is connected to the flip-flops 242-0 and 242-13, and the exclusive OR circuit 256-2 is connected to the flip-flops 242-13 and 242-10. The time-to-digital converting section 240 may output, as the digital value indicating the quantized time Q[tk], the number of an exclusive OR circuit 256 that outputs a logic value of 1.

A plurality of the time-to-digital converting sections 240 shown in FIGS. 10 and 12 may be provided in parallel. The time-to-digital converting sections 240 operate in an interleaved manner.

The level-crossing measuring section 210 may input the measurement data to a different time-to-digital converting section 240 each time the threshold level changes. Each time-to-digital converting section 240 may detect the quantized time Q[tk] by reading data from the flip-flop 242, while measurement data is input to another time-to-digital converting section 240.

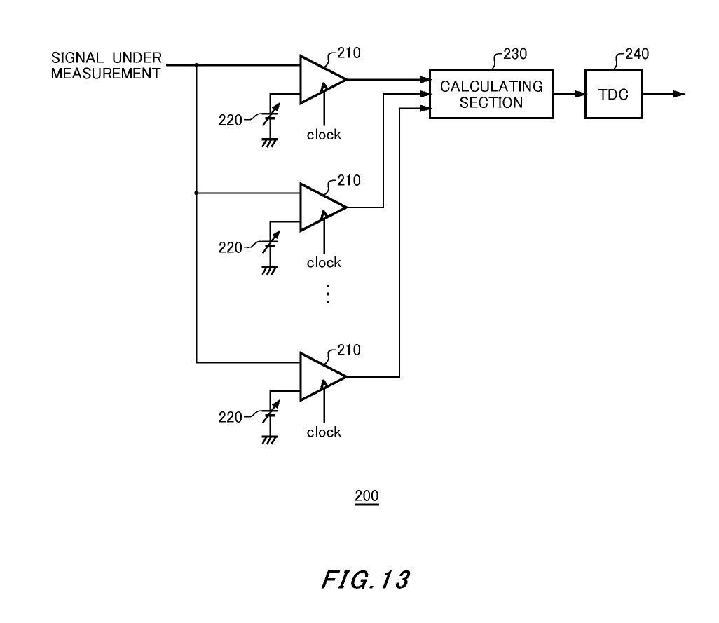

FIG. 13 shows another exemplary configuration of the measurement apparatus 200. The measurement apparatus 200 of the present embodiment includes a plurality of pairs of level-crossing measuring sections 210 and threshold setting sections 220, a calculating section 230, and a time-to-digital converting section 240. The level-crossing measuring sections 210 of the present embodiment are the clocked comparator described above.

The level-crossing measuring section 210 of the present embodiment receives a sampling clock whose period is the sum of the period of the signal under measurement and the time resolutions Tc=T/N. Each threshold setting section 220 is set to have the same setting value.

When the outputs of a number of level-crossing measuring sections 210 greater than or equal to a prescribed number transition, the calculating section 230 may transition the data values input to the time-to-digital converting section 240. For example, the calculating section 230 may transition the data values input to the time-to-digital converting section 240 when the outputs of a majority of the level-crossing measuring sections 210 transition. As a result, the effect of an error in a threshold level can be eliminated no matter which threshold level the error occurs in.

A time-to-digital converting section 240 may be provided for each level-crossing measuring section 210. In this case, the calculating section 230 may select the quantized time Q[tk] detected by a majority of the level-crossing measuring sections 210 and output this selected quantized time Q[tk]. In this case, the period of the sampling clock is not limited to a period equal to the sum of the period of the signal under measurement and the time resolutions Tc=T/N.

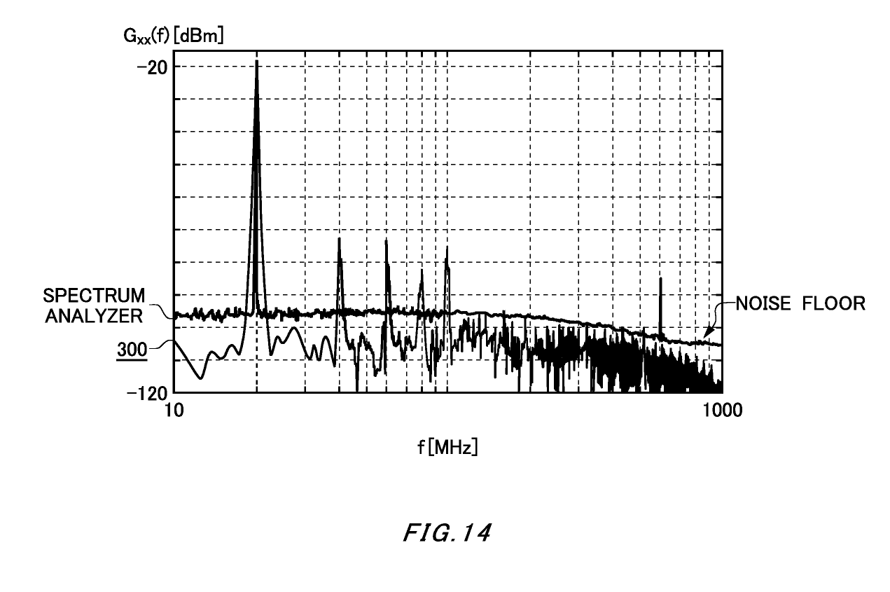

FIG. 14 shows a spectrum measured by the measurement system 300 and a spectrum measured by a spectrum analyzer. Here, the signal under measurement was a 20.05 MHz sinusoidal signal generated using a 14-bit arbitrary waveform generator. The sampling clock was generated as a 20.00 MHz square-wave signal.

The arbitrary waveform generator generates a signal by applying an analog filter with a cutoff frequency of 20 MHz to waveform data generated by a finite bit AD conversion. Therefore, the output signal of the arbitrary waveform generator includes internal noise, i.e. amplitude noise.

The measurement system 300 detected the quantized time Q[tk] for 22 threshold levels. Data processing was performed by the data processing apparatus 100 to generate waveform data with uniform time intervals, and the spectrum Gxx(f) was generated by performing a fast Fourier transform on the waveform data. The SINAD value was 52.11 dB, and the out-of-band SNR was 90.65 dB.

The spectrum Gxx(f) includes the harmonics caused by the time quantization noise described in relation to FIG. 4. However, the flat amplitude noise is not observed. On the other hand, in the spectrum obtained by the spectrum analyzer, a noise floor appears due to the internal noise of the arbitrary waveform generator.

Based on the results of FIG. 14, it can be seen that the measurement system 300 is not sensitive to amplitude noise. It can further be seen that the amplitude quantization noise generated by the measurement apparatus 200 is almost zero.

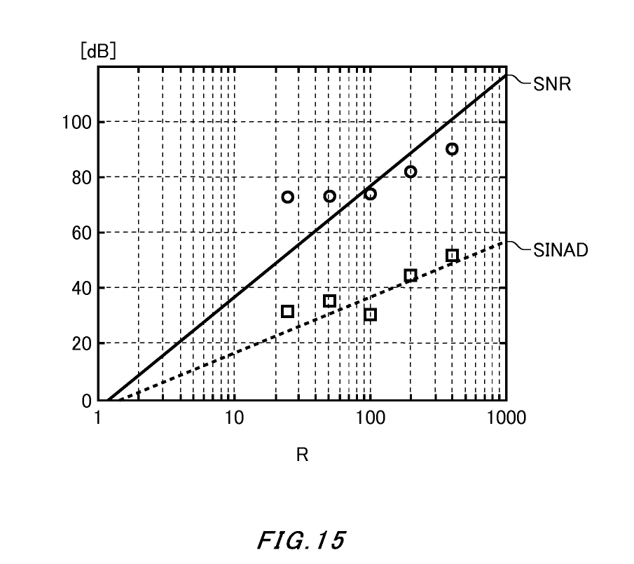

FIG. 15 shows measurement results of the SINAD and the SNR of the measurement system 300. Here, the resolution ratio R was changed between 25 and 400. The black circles in FIG. 15 represent measurement results for the SNR, and the black square represent measurement results for the SINAD.

As shown in FIG. 15, the SINAD value increases by 6 dB/Oct as a function of R. This matches the theoretical formulae of Expressions 2 and 3. The SNR value increases by 12 dB/Oct as a function of R. This matches the theoretical formula of Expression 6. Based on the above, it is understood that the measurement system 300 can achieve a high SNR over the out-of-band frequency, by using a sufficiently large resolution ratio R.

The measurement apparatus 200 described in relation to FIGS. 1 to 15 may be formed in an electronic device. This electronic device may include a circuit under measurement that outputs a signal under measurement. The measurement apparatus 200 is not sensitive to amplitude noise occurring inside the electronic device and the performance thereof can be dynamically controlled by changing the frequency of the sampling clock, and therefore the measurement apparatus 200 is suitable for on-chip measurement.

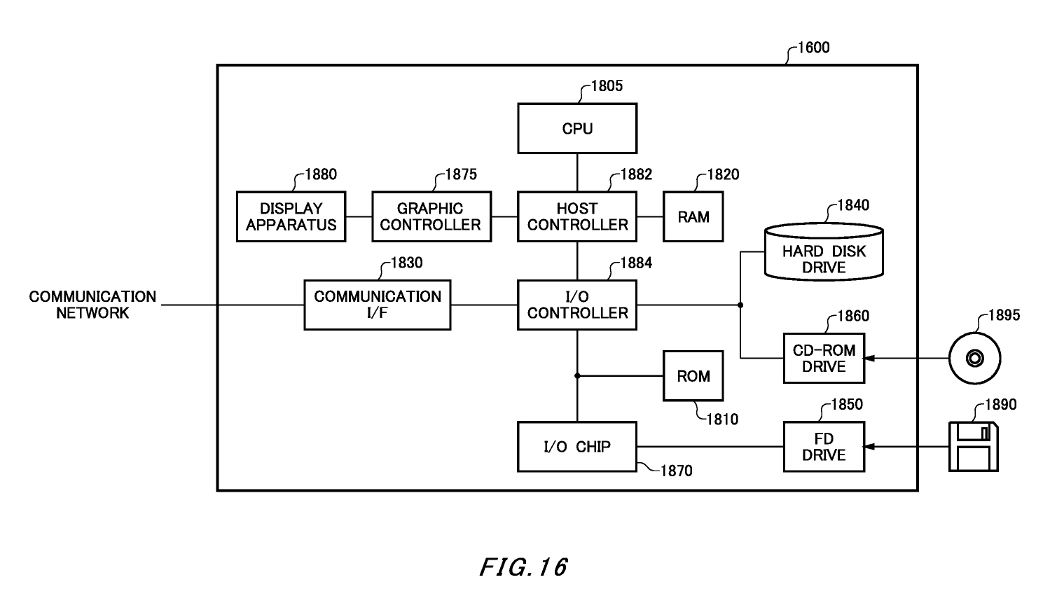

FIG. 16 shows an exemplary hardware configuration of a computer 1600 functioning as the data processing apparatus 100. The computer 1600 is provided with a CPU peripheral section, an input/output section, and a legacy input/output section. The CPU peripheral section includes a CPU 1805, a RAM 1820, a graphic controller 1875, and a display apparatus 1880 connected to each other by a host controller 1882.

The input/output section includes a communication interface 1830, a hard disk drive 1840, and a CD-ROM drive 1860, all of which are connected to the host controller 1882 by an input/output controller 1884. The legacy input/output section includes a ROM 1810, a flexible disk drive 1850, and an input/output chip 1870, all of which are connected to the input/output controller 1884.

The host controller 1882 is connected to the RAM 1820 and is also connected to the CPU 1805 and graphic controller 1875 accessing the RAM 1820 at a high transfer rate. The CPU 1805 operates to control each section based on programs stored in the ROM 1810 and the RAM 1820. The graphic controller 1875 acquires image data generated by the CPU 1805 or the like on a frame buffer disposed inside the RAM 1820 and displays the image data in the display apparatus 1880. Alternatively, the graphic controller 1875 may internally include the frame buffer storing the image data generated by the CPU 1805 or the like.

The input/output controller 1884 connects the hard disk drive 1840 serving as a relatively high speed input/output apparatus, the communication interface 1830, and the CD-ROM drive 1860 to the host controller 1882. The hard disk drive 1840 stores the programs and data used by the CPU 1805. The communication interface 1830 is connected to a network to send and receive the programs or the data. The CD-ROM drive 1860 reads the programs and data from a CD-ROM 1895 and provides the read information to the hard disk drive 1840 and the communication interface 1830 via the RAM 1820.

The input/output controller 1884 is connected to the ROM 1810, and is also connected to the flexible disk drive 1850 and the input/output chip 1870 serving as a relatively high speed input/output apparatus. The ROM 1810 stores a boot program performed when the computer 1600 starts up, a program relying on the hardware of the computer 1600, and the like.

The flexible disk drive 1850 reads the programs or data from a flexible disk 1890 and supplies the read information to the hard disk drive 1840 and the communication interface 1830 via the RAM 1820. The input/output chip 1870 connects the flexible disk drive 1850 to each of the input/output apparatuses via, a parallel port, a serial port, a keyboard port, a mouse port, or the like.

The programs performed by the CPU 1805 are stored on a recording medium such as the flexible disk 1890, the CD-ROM 1895, or an IC card and are provided by the user. The programs stored on the recording medium may be compressed or uncompressed. The programs are installed on the hard disk drive 1840 from the recording medium, are read by the RAM 1820, and are performed by the CPU 1805. The programs performed by the CPU 1805 cause the computer 1600 to function as the data processing apparatus 100 described in relation to FIGS. 1 to 15.

The programs shown above may be stored in an external storage medium. In addition to the flexible disk 1890 and the CD-ROM 1895, an optical recording medium such as a DVD or PD, a magneto-optical medium such as an MD, a tape medium, a semiconductor memory such as an IC card, or the like can be used as the recording medium. Furthermore, a storage apparatus such as a hard disk or a RAM disposed in a server system connected to the Internet or a specialized communication network may be used as the storage medium and the programs may be provided to the computer 1600 via the network.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A data processing apparatus that processes input data input thereto, comprising a time interpolation section that generates time interpolated data, in which level differences between pieces of data adjacent in time are a constant value, based on the input data.

2. The data processing apparatus according to claim 1, further comprising a portion extracting section that extracts a data portion in a predetermined time range in the input data, wherein
the time interpolation section generates the time interpolated data for the data portion.

3. The data processing apparatus according to claim 2, further comprising an amplitude interpolation section that generates amplitude interpolated data, which causes time differences between pieces of data adjacent in time to be a constant value, based on the time interpolated data generated by the time interpolation section.

4. The data processing apparatus according to claim 3, further comprising a frequency domain converting section that converts the amplitude interpolated data into a signal in the frequency domain.

5. The data processing apparatus according to claim 3, wherein
the portion extracting section extracts a rising edge portion and a falling edge portion of the input data, and
the time interpolation section generates the time interpolated data for the rising edge portion and the falling edge portion.

6. The data processing apparatus according to claim 5, further comprising a boundary data inserting section that inserts boundary data, corresponding to each data value of the rising edge portion and the falling edge portion, at a boundary between the rising edge portion and the falling edge portion in the amplitude interpolated data generated by the amplitude interpolation section.

7. A data processing system that processes input data, comprising:
a data generating apparatus that generates the input data; and
the data processing apparatus according to claim 1 that processes the input data generated by the data generating apparatus.

8. A measurement system that measures a signal under measurement, comprising:
a data measurement apparatus that generates measurement data obtained by measuring the signal under measurement; and
the data processing apparatus according to claim 1 that processes the measurement data generated by data measurement apparatus.

9. The measurement system according to claim 8, wherein
the data measurement apparatus outputs the measurement data indicating a comparison result between a signal level of the signal under measurement and a threshold level in a predetermined sampling period.

10. The measurement system according to claim 9, wherein
the data measurement apparatus outputs the measurement data for each of a plurality of threshold levels.

11. The measurement system according to claim 10, wherein the data measurement apparatus includes:
a clocked comparator that outputs the measurement data indicating a comparison result between the signal level of the signal under measurement and the threshold level in the sampling period; and
a threshold setting section that sequentially sets each of the plurality of threshold levels as the threshold level of the clocked comparator.

12. The measurement system according to claim 10, wherein
the data measurement apparatus includes a plurality of clocked comparators that each have a different threshold level and output the measurement data indicating a comparison result between the signal level of the signal under measurement and the threshold level in the sampling period.

13. The measurement system according to claim 8, wherein
the data measurement apparatus outputs the values of measurement data changing at level-crossing times at which the signal level of the signal under measurement crosses the threshold level.

14. The measurement system according to claim 13, wherein
the data measurement apparatus outputs the values of measurement data changing at level-crossing times at which the signal level of the signal under measurement crosses the threshold level, for each of a plurality of the threshold levels.

15. The measurement system according to claim 14, wherein the data measurement apparatus includes:
a threshold detection comparator that outputs the values of measurement data changing at level-crossing times at which the signal level of the signal under measurement crosses a set threshold level; and
a threshold setting section that sequentially sets the plurality of threshold levels as the threshold level of the threshold detection comparator.

16. The measurement system according to claim 14, wherein
the data measurement apparatus includes a plurality of threshold detection comparators that each have a different threshold level set therein and output the values of measurement data changing at level-crossing times at which the signal level of the signal under measurement crosses the threshold level.

17. The measurement system according to claim 9, wherein
the data measurement apparatus further includes a time-to-digital converting section that outputs digital values indicating level-crossing times at which the signal under measurement crosses the threshold level, based on the measurement data.

18. The measurement system according to claim 17, wherein
the time-to-digital converting section includes a storage section that stores the comparison results, compares predetermined combinations of the comparison results stored in the storage section, and outputs digital values indicating the level-crossing times.

19. The measurement system according to claim 17, wherein
the data measurement apparatus coherently samples the signal under measurement, and
the time-to-digital converting section rearranges each piece of data in the comparison results according to the period of the signal under measurement and the sampling period, and outputs digital values indicating level-crossing times at which the signal under measurement crosses the threshold level.

20. The measurement system according to claim 9, wherein
the data measurement apparatus includes a plurality of clocked comparators that receive the signal under measurement in parallel and each output comparison results between the signal level of the signal under measurement and the threshold level in the sampling period, and
the data measurement apparatus outputs the measurement data in which times at which the values of the comparison results of a predetermined number of clocked comparators or more transition are set as level-crossing times at which the signal under measurement crosses the threshold level.

21. A data processing method for processing input data, comprising:
generating time interpolated data, in which level differences between pieces of data adjacent in time are a constant value, based on the input data.

22. A measurement method for measuring a signal under measurement, comprising:
generating measurement data obtained by measuring the signal under measurement; and
processing the generated measurement data using the data processing method according to claim 21.

23. An electronic device in which the measurement system according to claim 8 is formed.

24. A recording medium storing thereon a program that causes a computer to function as the data processing apparatus according to claim 1.
